(19) United States
(12) Patent Application Publication
(10) Pub. No.: US 2026/0292017 A1
(43) Pub. Date: Sep. 24, 2026

(54) METHOD AND SYSTEM FOR ACCESSING SHARED FILES

(71) Applicant: Wistron Corp., New Taipei City (TW)

(72) Inventor: Qiaoping ZHANG, New Taipei City (TW)

(21) Appl. No.: 19/216,804

(22) Filed: May 23, 2025

(30) Foreign Application Priority Data
Mar. 19, 2025 (CN) 202510331378.8

(51) Int. Cl. H04L 67/06

(52) U.S. Cl. CPC H04L 67/06

(57) ABSTRACT

A method for accessing shared files is provided. The method is implemented by an electronic device and includes receiving a download request, wherein the download request is used to request to download a first file. The method includes determining whether the first file is recorded in a shared file directory. The method includes sending the download request to a network server when the first file is recorded in the shared file directory. The method includes receiving a first scheduling response sent by the network server, wherein the first scheduling response indicates that a first client device in a local area network (LAN) has the first file. The method includes downloading the first file from the first client device according to the first scheduling response.

### CROSS REFERENCE TO RELATED APPLICATIONS

This application claims priority of China Patent Application No. 202510331378.8, filed on Mar. 19, 2025, the entirety of which is incorporated by reference herein.

### TECHNICAL FIELD

The present disclosure generally relates to the field of network communication technology. More specifically, aspects of the present disclosure relate to a method and a system for accessing shared files in a local area network (LAN).

### BACKGROUND

In a local area network, a server is usually set up to store shared folders that multiple client devices can access using the Server Message Block (SMB) protocol. As shown in FIG. 1, a shared folder is stored in a server 110, and the client devices 120A-120E can access the shared folder in the server 110 via the SMB protocol.

However, since the client devices 120A-120E do not communicate with each other, the load and network traffic pressure of the server 110 may increase significantly when the client devices 120A-120E want to access the shared files in the shared folder at the same time, causing the speed of the client devices 120A-120E accessing the shared files to slow down.

Therefore, how to improve the efficiency of shared file access in a local area network and reduce the burden on the server has become a problem that needs to be solved urgently.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, to solve the above technical problems, the main purpose of the present disclosure is to provide a method and system for accessing shared files to reduce the burden of the server and improve the access efficiency of shared files.

In an exemplary embodiment, a method for accessing shared files is provided. The method is implemented by an electronic device and comprises receiving, by a processor of the electronic device, a download request, wherein the download request is used to request to download a first file. The method includes determining, by the processor, whether the first file is recorded in a shared file directory. The method includes sending, by the processor, the download request to a network server when the first file is recorded in the shared file directory. The method includes receiving, by the processor, a first scheduling response sent by the network server, wherein the first scheduling response indicates that a first client device in a local area network (LAN) has the first file. The method includes downloading, by the processor, the first file from the first client device according to the first scheduling response.

In some embodiments, the method further comprises storing the first file in a buffer of the electronic device.

In some embodiments, the method further comprises sending, by the processor, a feedback message to the network server to inform the network server that the electronic device has stored the first file.

In some embodiments, the network server has a cache record table, and the cache record table records file-holding information of each client device in the local area network.

In some embodiments, the method further comprises sending, by the processor, the download request to the network server via a server message block (SMB) protocol when the first file is not recorded in the shared file directory. The method further comprises receiving, by the processor, the first file sent by the network server through the SMB protocol.

In some embodiments, the method further comprises receiving, by the processor, an access request, wherein the access request is used to request access to a second file. The method further comprises determining, by the processor, whether the second file is recorded in the shared file directory. The method further comprises determining, by the processor, whether the second file is in a buffer of the electronic device when the second file is recorded in the shared file directory. The method further comprises accessing, by the processor, the second file from the buffer when the second file is in the buffer.

In some embodiments, the method further comprises sending, by the processor, the access request to the network server when the second file is not in the buffer. The method further comprises receiving, by the processor, a second scheduling response sent by the network server, wherein the second scheduling response indicates that a second client device in the LAN has the second file. The method further comprises accessing, by the processor, the second file from the second client device according to the second scheduling response.

In some embodiments, the method further comprises receiving, by the processor, the second file sent by the network server and accessing the second file.

In some embodiments, the step of downloading the first file from the first client device according to the first scheduling response further comprises sending the download request to the first client device and downloading the first file directly from the first client device without going through the network server.

In some embodiments, the electronic device, the network server and the first client device are in the local area network.

In an exemplary embodiment, a system for accessing shared files is provided. The system comprises a network server and an electronic device. The electronic device is connected to the network server. The electronic device executes the following tasks: receiving a download request, wherein the download request is used to request to download a first file; determining whether the first file is recorded in a shared file directory; sending the download request to a network server when the first file is recorded in the shared file directory; receiving a first scheduling response sent by the network server, wherein the first scheduling response indicates that a first client device in a local area network (LAN) has the first file; and downloading the first file from the first client device according to the first scheduling response.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram of traditional access shared files.

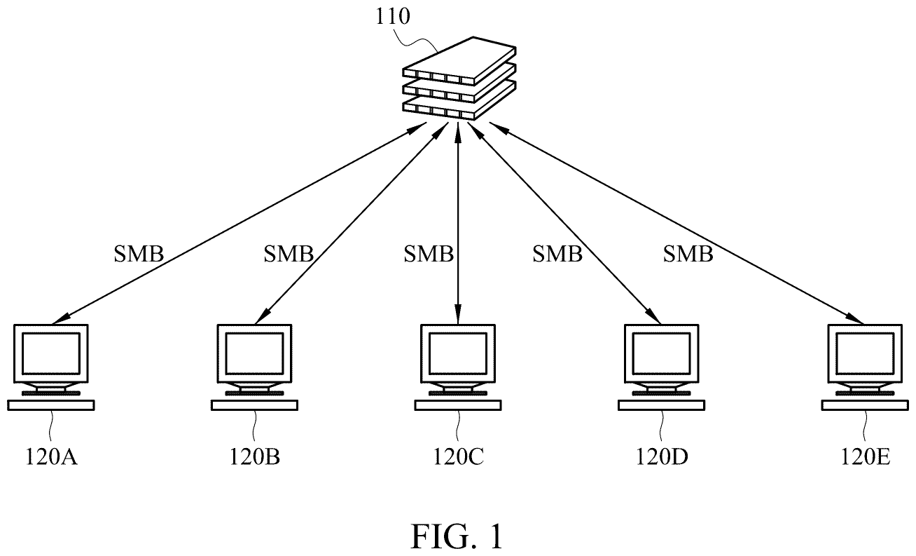

FIG. 2 is a schematic diagram of a system for accessing shared files according to an embodiment of the present disclosure.

FIG. 3 is a block diagram showing an exemplary client device according to an embodiment of the present disclosure.

FIG. 4 is a timing flowchart showing a method for accessing shared files according to an embodiment of the present disclosure with reference to FIG. 2.

FIG. 5 is a timing flowchart showing a method for accessing shared files according to an embodiment of the present disclosure with reference to FIG. 2.

FIG. 6 is a timing flowchart showing a method for accessing shared files according to an embodiment of the present disclosure, with reference to FIG. 2.

FIG. 7 is a flow chart showing a method for accessing shared files according to an embodiment of the present disclosure.

FIG. 8 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

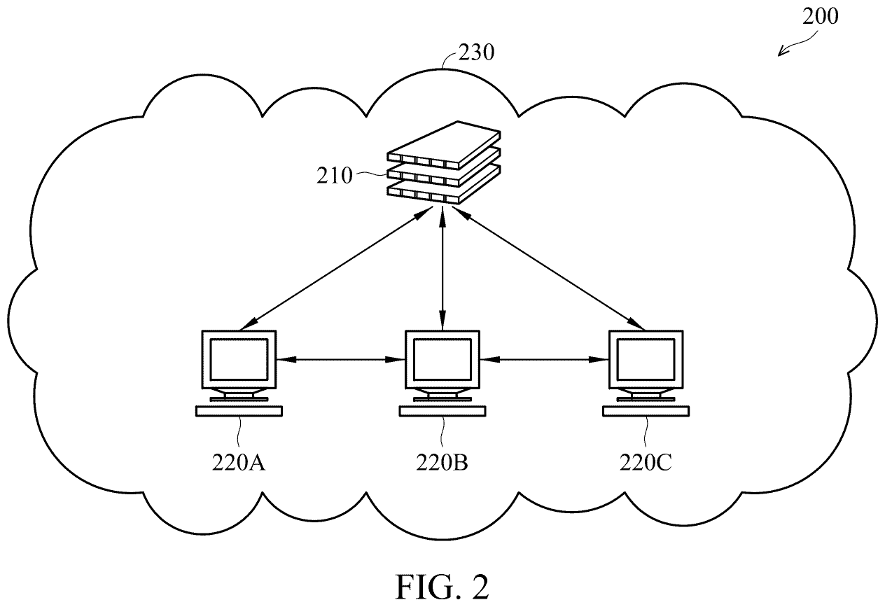

FIG. 2 is a schematic diagram of a system 200 for accessing shared files according to an embodiment of the present disclosure.

As shown in FIG. 2, the system 200 may comprise a network server 210 and client devices 220A, 220B, and 220C, wherein the network server 210 and the client devices 220A, 220B, and 220C are in a local area network (LAN) 230.

The client devices 220A, 220B and 220C are connected to the network server 210 via the local area network 230, and the client devices 220A, 220B and 220C may also communicate with each other via the local area network 230.

The network server 210 supports a local area network shared protocol and may and may serve as a share server to provide shared data. In addition, the network server 210 has a cache record table, and the cache record table records the file-holding information of each client device in the local area network 230. In other words, the network server 210 may obtain information such as documents or files held by each client device by querying the cache record table.

The client devices 220A, 220B and 220C also support the local area network shared access protocol and may serve as a sharing client device to access the shared files in the network server 210. In some embodiments, the client devices 220A, 220B, and 220C may be various electronic devices, including but not limited to smart phones, tablet computers, laptop computers, portable notebook computers, and desktop computers, or the like.

In some embodiments, the LAN shared access protocol may be a server message block (SMB) protocol. The SMB Protocol is a communication protocol for sharing resources such as a file and a printer on a local area network and providing services for sharing the resources such as a file and a printer between different computers on the local area network. The SMB protocol is a client/server and request/response protocol. By using the SMB protocol, a client device may read and write a file in a server in various network environments and send a service request to the server. In addition, the client may further access resources such as a file, a printer, a mailslot, and a named pipe on a remote server by using the SMB protocol.

It should be noted that the number of the client devices is not used to limit the present disclosure, and those skilled in the art can make appropriate replacements or adjustments according to this embodiment.

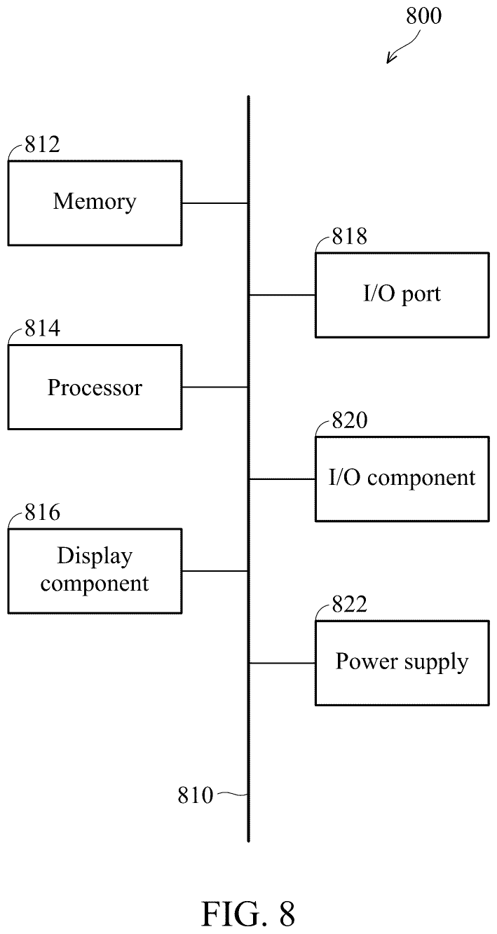

It should be understood that the network server 210 and the client devices 220A, 220B and 220C shown in FIG. 2 is an example of one suitable system 200 architecture accessing shared files. Each of the components shown in FIG. 2 may be implemented via any type of electronic device, such as the electronic device 800 described with reference to FIG. 8, for example.

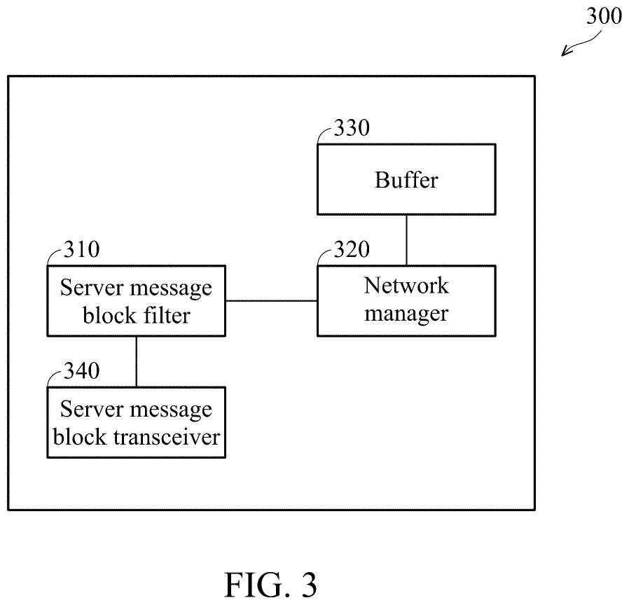

FIG. 3 is a block diagram showing an exemplary client device 300 according to an embodiment of the present disclosure. The client device 300 may be one of the client devices 220A, 220B, and 220C in FIG. 2.

The client device 300 may comprise a server message block filter 310, a network manager 320, a buffer 330 and a server message block transceiver 340, wherein the server message block filter 310 is connected to the network manager 320 and the server message block transceiver 340, and the buffer 330 is connected to the network manager 320.

The server message block filter 310 may receive a download request input by a user, wherein the download request is used to request to download a first file. The server message block filter 310 is responsible for intercepting the download request and determining whether the first file is recorded in a shared file directory. In another embodiment, when the client device 300 is initialized, a shared file directory corresponding to the client device 300 may be pre-loaded in the server message block filter 310, wherein the shared file directory records information such as the IP addresses corresponding to the shared files of concern to the client device 300 and names of folders where the shared files are located. In another embodiment, the shared file directory may be updated and modified by the network server.

When the server message block filter 310 determines that the first file is recorded in the shared file directory, the server message block filter 310 transmits the download request to the network manager 320. The network manager 320 is responsible for communicating with other client devices and network servers in the same local area network as the client device 300. After receiving the download request from the server block filter 310, the network manager 320 transmits the download request to the network server.

After the network server receives the download request, the network server may query the cache record table according to the download request and return a first scheduling response to assist the client device in determining from which client device to obtain the first file.

Next, the network manager 320 receives a first scheduling response sent by the network server, wherein the first scheduling response indicates that a first client device in the local area network has the first file. In one embodiment, the first client device and the client device 300 are in the same local area network.

The network manager 320 downloads the first file from the first client device according to the first scheduling response, wherein the first file is stored in the buffer 330 of the client device 300. Specifically, the network manager 320 sends the download request to the first client device according to the first scheduling response. The network manager 320 communicates directly with the first client device and directly downloads the first file from the first client device without going through the network server. In one embodiment, the network manager 320 may send a feedback message to the network server to inform the network server that the client device 300 has stored the first file. The network server may update the cache record table according to the feedback message.

When the server block filter 310 determines that the first file is not recorded in the shared file directory, the server block filter 310 transmits the download request to the server block transceiver 340. The server message block transceiver 340 transmits the download request to the network server via a server message block (SMB) protocol, and receives the first file transmitted by the network server via the SMB protocol.

In addition, the server message block filter 310 may further receive an access request input by a user, wherein the access request is used to request access to a second file. The server message block filter 310 is responsible for intercepting the access request and determining whether the second file is recorded in the shared file directory. When the second file is recorded in the shared file directory, the server block filter 310 determines whether the second file is in the buffer 330. When the second file is in the buffer 330, the network manager 320 accesses the second file from the buffer 320.

When the second file is not in the buffer 330, the server block filter 310 transmits the access request to the network manager 320. After receiving the access request from the server block filter 310, the network manager 320 transmits the access request to the network server.

Next, the network manager 320 receives a second scheduling response sent by the network server, wherein the second scheduling response indicates that a second client device in the local area network has the second file. In one embodiment, the second client device and the client device 300 are in the same local area network.

The network manager 320 accesses the second file from the second client device according to the second scheduling response. In yet another embodiment, the second file may be stored in the buffer 330 of the client device 300. In another embodiment, the network manager 320 may send a feedback message to the network server to inform the network server that the client device 300 has stored the second file. The network server may update the cache record table according to the feedback message.

When the second file is not recorded in the shared file directory, the server block filter 310 transmits the access request to the server block transceiver 340. The server message block transceiver 340 transmits the access request to the network server via the SMB protocol, receives the second file transmitted by the network server via the SMB protocol, and accesses the second file.

The following is an example to illustrate how the server message block filter 310 determines whether the file requested in the download request or the file requested in the access request is recorded in the shared file directory. TABLE 1 is a shared file directory stored in the server block filter 310.

TABLE 1

sharePath1=\\10.43.146.61\share
sharePath2=\\10.43.146.62\share1

As shown in TABLE 1, TABLE 1 records that the IP addresses corresponding to the shared file of concern to the client device 300 are 10.43.146.61 and 10.43.146.62, and the folders where the shared files are located are named share and share1.

The download request or the access request may include the IP addresses of the shared files and the names of the folders where the shared files are located, for example, \\10.43.146.61\share\test.exe. The server block filter 310 may determine that the shared file is recorded in TABLE 1 according to the IP address of the shared file.

The following is an example to illustrate the cache record table in the network server. TABLE 2 is shown below.

TABLE 2

| IP: 192.168.0.1; count: 0 | IP: 192.168.0.2; count: 2 |
|---|---|
| Filename: share\test.exe | Filename: share\test.exe |
| Index: 001 | Index: 001 |
| Offset: 0 | Offset: 0 |
| Size: 10240 | Size: 10240 |
| Filename: share\test.exe | Filename: share\test.exe |
| Index: 002 | Index: 002 |
| Offset: 10241 | Offset: 10241 |
| Size: 1024 | Size: 1024 |
| Filename: share\test001.exe | Filename: share\test001.exe |
| Index: 002 | Index: 002 |
| Offset: 11264 | Offset: 11264 |
| Size: 9216 | Size: 9216 |

As shown in TABLE 2, the cache record table records the IP address of each client device and the file names (FileName), indexes (Index), file sizes (Size) and file offsets (Offset) stored by each client device. The network server may determine from which client device the client device 300 may obtain the shared file according to the cache record table in TABLE 2.

It should be noted that the server message block filter 310, the network manager 320 and the server message block transceiver 340 in FIG. 3 may be implemented in hardware, software, firmware or any combination thereof. For example, the server block filter 310, the network manager 320, and the server block transceiver 340 may be implemented as computer program code configured to execute in one or more processors. Alternatively, the server block filter 310, the network manager 320, and the server block transceiver 340 may be implemented as hardware logic/electrical circuitry.

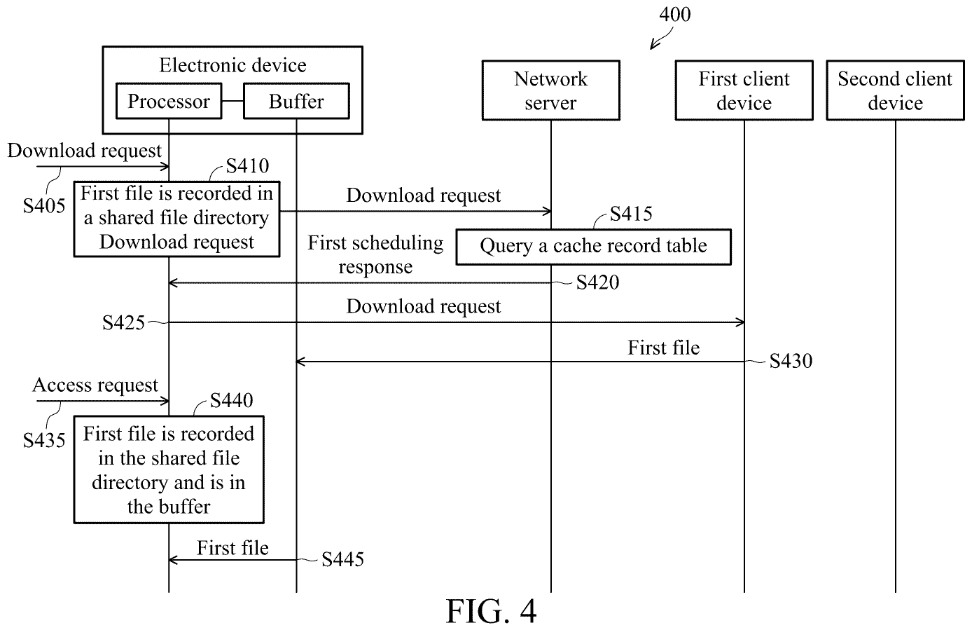

FIG. 4 is a timing flowchart 400 showing a method for accessing shared files according to an embodiment of the present disclosure with reference to FIG. 2. As shown in FIG. 4, the electronic device may be a client device and is in the same local area network as the first client device, the second client device, and the network server. For ease of illustration, the electronic device only shows a processor and a buffer.

FIG. 4 depicts a situation where a first file is recorded in a shared file directory.

In step S405, the processor of the electronic device may receive a download request, wherein the download request is used to request to download a first file.

In step S410, the processor determines that the first file is recorded in a shared file directory and sends the download request to the network server.

In step S415, the network server queries a cache record table according to the download request.

In step S420, the network server sends a first scheduling response to the processor, wherein the first scheduling response indicates that a first client device in a local area network (LAN) has the first file.

In step S425, the processor transmits the download request to the first client device.

In step S430, the processor directly downloads the first file from the first client device to the buffer without going through the network server.

In step S435, the processor receives an access request, wherein the access request is used to request access to a first file.

In step S440, the processor determines that the first file is recorded in the shared file directory and is in the buffer of the electronic device.

In step S445, the processor accesses the first file from the buffer.

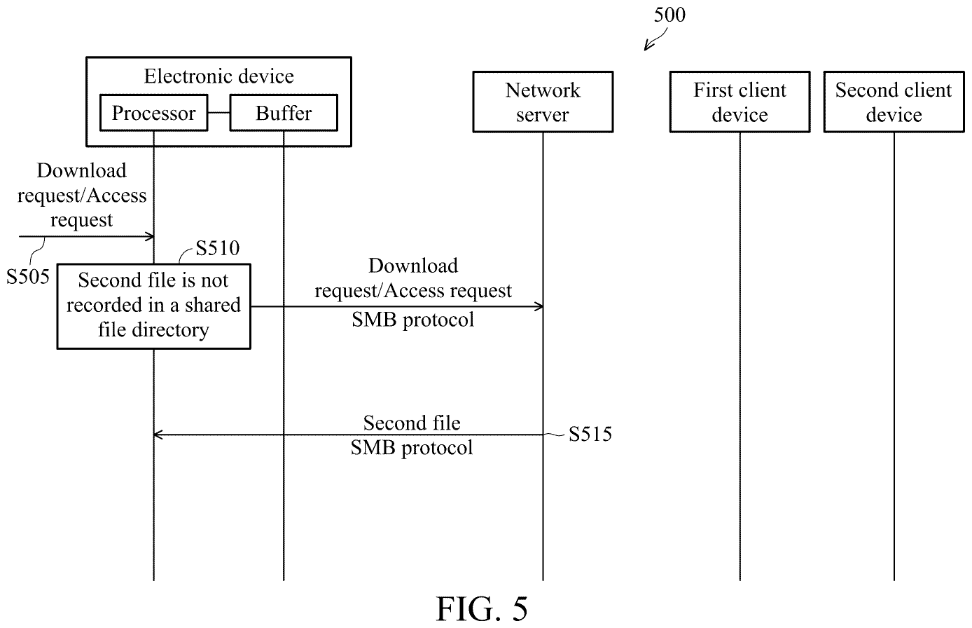

FIG. 5 is a timing flowchart 500 showing a method for accessing shared files according to an embodiment of the present disclosure with reference to FIG. 2. As shown in FIG. 5, the electronic device may be a client device and is in the same local area network as the first client device, the second client device, and the network server. For ease of illustration, the electronic device only shows a processor and a buffer.

FIG. 5 depicts a situation where the second file is not recorded in a shared file directory.

In step S505, the processor of the electronic device may receive a download request or an access request, wherein the download request is used to request to download a second file, and the access request is used to request access to the second file.

In step S510, the processor determines that the second file is not recorded in a shared file directory and transmits the download request or the access request to the network server via the SMB protocol.

In step S515, the network server transmits the second file to the processor of the electronic device via the SMB protocol, so that the processor may download or access the second file.

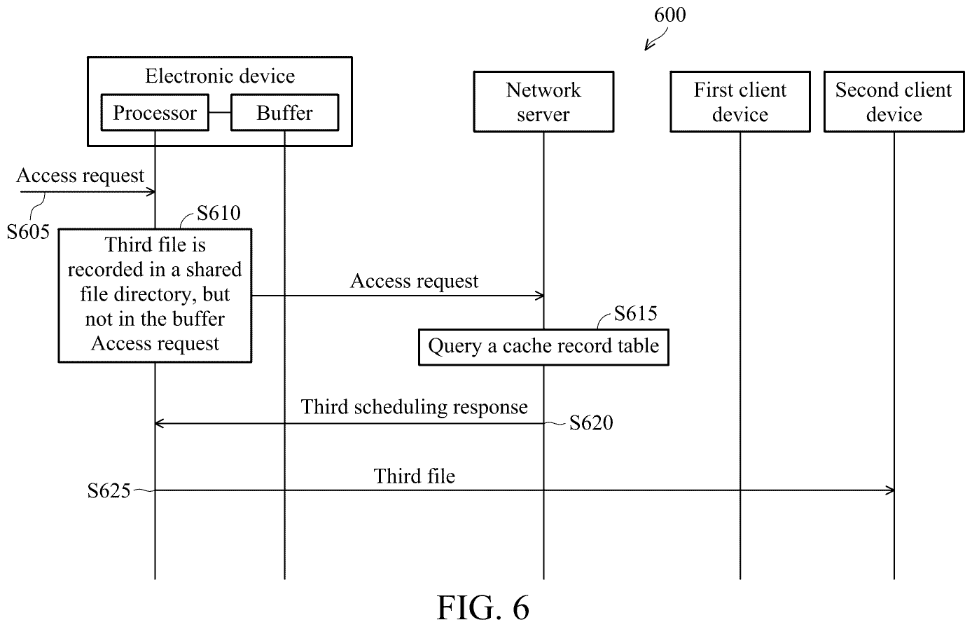

FIG. 6 is a timing flowchart 600 showing a method for accessing shared files according to an embodiment of the present disclosure, with reference to FIG. 2. As shown in FIG. 6, the electronic device may be a client device and is in the same local area network as the first client device, the second client device, and the network server. For ease of illustration, the electronic device only shows a processor and a buffer.

FIG. 6 illustrates a situation where a third file is recorded in a shared file directory but not in the buffer of the electronic device.

In step S605, the processor of the electronic device may receive an access request, wherein the access request is used to request access to a third file.

In step S610, the processor determines that the third file is recorded in a shared file directory and that the third file is not in the buffer of the electronic device. The processor transmits the access request to the network server.

In step S615, the network server queries a cache record table according to the access request.

In step S620, the network server sends a third scheduling response to the processor, wherein the third scheduling response indicates that a second client device in the local area network has the third file.

In step S625, the processor accesses the third file from the second client device according to the third scheduling response.

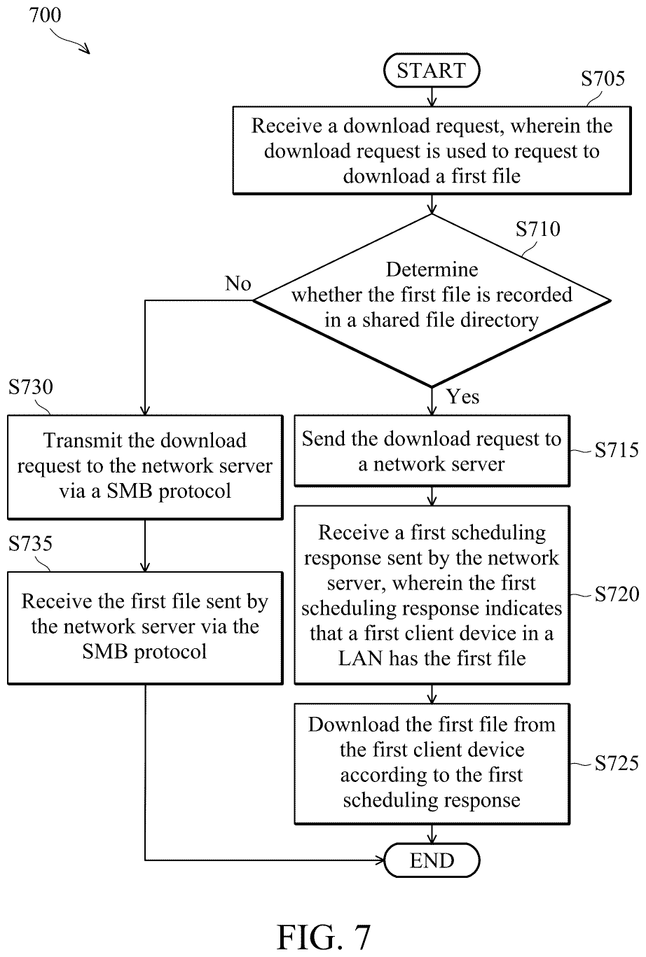

FIG. 7 is a flow chart showing a method 700 for accessing shared files according to an embodiment of the present disclosure. The method may be implemented by the network server 210 and an electronic device as one of the client devices 220A, 220B and 220C in the system 100 for accessing shared files shown in FIG. 2.

In step S705, a processor of the electronic device receives a download request, wherein the download request is used to request to download a first file.

In step S710, the processor determines whether the first file is recorded in a shared file directory.

When the first file is recorded in the shared file directory (“Yes” in step S710), in step S715, the processor sends the download request to a network server.

In step S720, the processor receives a first scheduling response sent by the network server, wherein the first scheduling response indicates that a first client device in a local area network (LAN) has the first file.

In step S725, the processor downloads the first file from the first client device according to the first scheduling response, wherein the processor stores the first file in a buffer of the electronic device.

When the first file is not recorded in the shared file directory (“No” in step S710), in step S730, the processor transmits the download request to the network server via a server message block (SMB) protocol.

In step S735, the processor receives the first file sent by the network server via the SMB protocol. In some embodiments, the processor may first send the download request to the first client device, and then directly download the first file from the first client device without going through the network server.

In some embodiments, when the processor has finished downloading the first file, the processor may send a feedback message to the network server to notify the network server that the electronic device has stored the first file.

In another embodiment, the network server has a cache record table, and the cache record table records the file-holding information of each client device in the local area network.

In some embodiments, the processor may further receive an access request, wherein the access request is used to request access to a second file. The processor determines whether the second file is recorded in the shared file directory. When the second file is recorded in the shared file directory, the processor determines whether the second file is in a buffer of the electronic device. When the second file is in the buffer, the processor accesses the second file from the buffer. When the second file is not in the buffer, the processor sends the access request to the network server. Next, the processor receives a second scheduling response sent by the network server, wherein the second scheduling response indicates that a second client device in the local area network has the second file. The processor accesses the second file from the second client device according to the second scheduling response.

In some embodiments, when the second file is not recorded in the shared file directory, the processor sends the access request to the network server via a server message block (SMB) protocol. The processor receives the second file transmitted by the network server and accesses the second file.

In some embodiments, the electronic device, the network server, the first client device and the second client device are in the same local area network.

As described above, the method and system for accessing shared files proposed in the present disclosure adopt decentralized cache management. The client devices communicate with each other through the network managers in the client devices and provide shared files. Each client device's buffer may store data owned by other client devices, thereby optimizing the overall file access path.

When a client device needs a file but the file is not in its own buffer, the client device may first request the network server to query whether other client devices have the required file. When all client devices do not have the file, the client device may request the network server to provide the file. The method and system for accessing shared files provided in the present disclosure may reduce the frequency of client devices accessing the server, while achieving fast connection using a local area network, thereby accelerating data transmission between client devices.

In addition, the method and system for accessing shared files provided in the present disclosure may provide the following advantages:

### 1. Reduce the Burden on the Server

By sharing files in a buffer between client devices, the present disclosure may significantly reduce the number of times the client devices directly access files from the server. The server may only serve as the final source of the file when all client devices do not have the file, thus significantly reducing the server load pressure.

### 2. Improve Access Efficiency

Since files may be shared quickly between client devices, client devices may obtain files at a higher speed in the local area network. This not only shortens the waiting time, but also avoids the delay caused by the client device requesting a large number of files from the server, thereby improving the efficiency of accessing files.

### 3. Optimize Network Traffic

The present disclosure reduces a large amount of file traffic flowing through the network to the network server by distributing requests among client devices in a local area network, thereby optimizing network traffic. File transfers within a local area network are usually faster and more stable than those via a wide area network or the Internet, further improving data transfer efficiency.

### 4. Improve File Reliability and Availability

File sharing between client devices allows for multiple backups of files. When a file on a certain client device is not available, other client devices may still provide the same file, thereby increasing the reliability and availability of the file.

The embodiments described herein, including systems, methods/processes, and/or apparatuses, may be implemented using well known computers, such as the electronic device 800 shown in FIG. 8. The electronic device 800 is described as follows, for purposes of illustration.

Referring to FIG. 8, an exemplary operating environment for implementing embodiments of the present disclosure is shown and generally known as an electronic device 800. The electronic device 800 is merely an example of a suitable computing environment and is not intended to limit the scope of use or functionality of the disclosure. Neither should the electronic device 800 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 8, the electronic device 800 may include a bus 810 that is directly or indirectly coupled to the following devices: one or more memories 812, one or more processors 814, one or more display components 816, one or more input/output (I/O) ports 818, one or more input/output components 820, and an illustrative power supply 822. The bus 810 may represent one or more kinds of buses (such as an address bus, data bus, or any combination thereof). Although the various blocks of FIG. 8 are shown with lines for the sake of clarity, and in reality, the boundaries of the various components are not specific. For example, the display component such as a display device may be considered an I/O component and the processor may include a memory.

The electronic device 800 typically includes a variety of computer-readable media. The computer-readable media can be any available media that can be accessed by electronic device 800 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 800. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 812 may include computer-storage media in the form of volatile and/or nonvolatile memory. The memory may be removable, non-removable, or a combination thereof. Exemplary hardware devices include solid-state memory, hard drives, optical-disc drives, etc. The electronic device 800 includes one or more processors that read data from various entities such as the memory 812 or the I/O components 820. The display component(s) 816 present data indications to a user or to another device. Exemplary presentation components include a display device, speaker, printing component, vibrating component, etc.

The I/O ports 818 allow the electronic device 800 to be logically coupled to other devices including the I/O components 820, some of which may be embedded. Illustrative components include a microphone, joystick, game pad, satellite dish, scanner, printer, wireless device, etc. The I/O components 820 may provide a natural user interface (NUI) that processes gestures, voice, or other physiological inputs generated by a user. For example, inputs may be transmitted to an appropriate network element for further processing. The electronic device 800 may be equipped with depth cameras, such as stereoscopic camera systems, infrared camera systems, RGB camera systems, or any combination thereof, to detect and identify objects. In addition, the electronic device 800 may be equipped with sensors (e.g., radar, lidar) to periodically sense the surrounding environment within a sensing range and generate sensor information representing the relationship between the electronic device 800 and the surrounding environment. Furthermore, the electronic device 800 may be equipped with accelerometers or gyroscopes that enable detection of motion. The output of the accelerometers or gyroscopes may be provided to the electronic device 800 for display.

Furthermore, the processor 814 in the electronic device 800 can execute the program code in the memory 812 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded with the broadest interpretation so as to encompass all such modifications and similar arrangements.

What is claimed is:

1. A method for accessing shared files, wherein the method is implemented by an electronic device, and comprises:
receiving, by a processor of the electronic device, a download request, wherein the download request is used to request to download a first file;
determining, by the processor, whether the first file is recorded in a shared file directory;
sending, by the processor, the download request to a network server when the first file is recorded in the shared file directory;
receiving, by the processor, a first scheduling response sent by the network server, wherein the first scheduling response indicates that a first client device in a local area network (LAN) has the first file; and
downloading, by the processor, the first file from the first client device according to the first scheduling response.

2. The method for accessing shared files as claimed in claim 1, further comprising:
storing the first file in a buffer of the electronic device.

3. The method for accessing shared files as claimed in claim 1, further comprising:
sending, by the processor, a feedback message to the network server to inform the network server that the electronic device has stored the first file.

4. The method for accessing shared files as claimed in claim 1, wherein the network server has a cache record table, and the cache record table records file-holding information of each client device in the local area network.

5. The method for accessing shared files as claimed in claim 1, further comprising:
sending, by the processor, the download request to the network server via a server message block (SMB) protocol when the first file is not recorded in the shared file directory; and
receiving, by the processor, the first file sent by the network server through the SMB protocol.

6. The method for accessing shared files as claimed in claim 1, further comprising:
receiving, by the processor, an access request, wherein the access request is used to request access to a second file;
determining, by the processor, whether the second file is recorded in the shared file directory;
determining, by the processor, whether the second file is in a buffer of the electronic device when the second file is recorded in the shared file directory; and
accessing, by the processor, the second file from the buffer when the second file is in the buffer.

7. The method for accessing shared files as claimed in claim 6, further comprising:
sending, by the processor, the access request to the network server when the second file is not in the buffer;
receiving, by the processor, a second scheduling response sent by the network server, wherein the second scheduling response indicates that a second client device in the LAN has the second file; and
accessing, by the processor, the second file from the second client device according to the second scheduling response.

8. The method for accessing shared files as claimed in claim 6, further comprising:
sending, by the processor, the access request to the network server via a server message block (SMB) protocol when the second file is not in the shared file directory; and
receiving, by the processor, the second file sent by the network server and accessing the second file.

9. The method for accessing shared files as claimed in claim 1, wherein the step of downloading the first file from the first client device according to the first scheduling response further comprises:
sending the download request to the first client device; and
downloading the first file directly from the first client device without going through the network server.

10. The method for accessing shared files as claimed in claim 1, wherein the electronic device, the network server and the first client device are in the local area network.

11. A system for accessing shared files, comprising:
a network server; and
an electronic device, connected to the network server, wherein the electronic device executes the following tasks:
receiving a download request, wherein the download request is used to request to download a first file;
determining whether the first file is recorded in a shared file directory;
sending the download request to a network server when the first file is recorded in the shared file directory;
receiving a first scheduling response sent by the network server, wherein the first scheduling response indicates that a first client device in a local area network (LAN) has the first file; and
downloading the first file from the first client device according to the first scheduling response.

12. The system for accessing shared files as claimed in claim 11, wherein the electronic device further executes the following tasks:
storing the first file in a buffer of the electronic device.

13. The system for accessing shared files as claimed in claim 11, wherein the electronic device further executes the following tasks:
sending a feedback message to the network server to inform the network server that the electronic device has stored the first file.

14. The system for accessing shared files as claimed in claim 11, wherein the network server has a cache record table, and the cache record table records file-holding information of each client device in the local area network.

15. The system for accessing shared files as claimed in claim 11, wherein the electronic device further executes the following tasks:
sending the download request to the network server via a server message block (SMB) protocol when the first file is not recorded in the shared file directory; and
receiving the first file sent by the network server through the SMB protocol.

16. The system for accessing shared files as claimed in claim 11, wherein the electronic device further executes the following tasks:
receiving an access request, wherein the access request is used to request access to a second file;
determining whether the second file is recorded in the shared file directory;
determining whether the second file is in a buffer of the electronic device when the second file is recorded in the shared file directory; and
accessing the second file from the buffer when the second file is in the buffer.

17. The system for accessing shared files as claimed in claim 16, wherein the electronic device further executes the following tasks:
sending the access request to the network server when the second file is not in the buffer;
receiving a second scheduling response sent by the network server, wherein the second scheduling response indicates that a second client device in the LAN has the second file; and
accessing the second file from the second client device according to the second scheduling response.

18. The system for accessing shared files as claimed in claim 16, wherein the electronic device further executes the following tasks:
sending the access request to the network server via a server message block (SMB) protocol when the second file is not in the shared file directory; and
receiving the second file sent by the network server and accessing the second file.

19. The system for accessing shared files as claimed in claim 11, wherein the step in which the electronic device downloads the first file from the first client device according to the first scheduling response further comprises:
sending the download request to the first client device; and
downloading the first file directly from the first client device without going through the network server.

20. The system for accessing shared files as claimed in claim 11, wherein the electronic device, the network server and the first client device are in the local area network.
